(19) United States
(12) Patent Application Publication
(10) Pub. No.: US 2009/0214743 A1
(43) Pub. Date: Aug. 27, 2009

(54) METHOD FOR PRODUCING AND PACKAGING JUICE

(75) Inventors: Jin-E Shin, Hoffman Estates, IL (US); Jeanette Stephen, Arlington Heights, IL (US); Amenah I. Ibrahim, Chicago, IL (US); Bryan Hitchcock, Vernon Hills, IL (US); Rachel L. Jordan, Palatine, IL (US)

Correspondence Address: BANNER & WITCOFF, LTD.;and ATTORNEYS FOR CLIENT NO. 006943, 10 SOUTH WACKER DR., SUITE 3000, CHICAGO, IL, 60606, US

(73) Assignee: TROPICANA PRODUCTS INC., Bradenton, FL (US)

(21) Appl. No.: 12/035,203

(22) Filed: Feb. 21, 2008

(51) Int. Cl. A23L 2/04; A23L 2/02; A23L 2/46; A23L 2/76

(52) U.S. Cl. 426/599; 426/489; 426/404

(57) ABSTRACT

Producing juice having increased nutritional and organoleptic value by extracting the juice under an atmosphere having an oxygen concentration of less than about 10 percent.

### FIELD OF THE INVENTION

The invention relates to a method for producing and packaging juice. In particular, the invention relates to a continuous method for producing and packaging fruit juice under reduced oxygen conditions. The invention also relates to juice produced in accordance with the method.

### BACKGROUND OF THE INVENTION

Shelf stability and product quality of juice is of concern to both producers and consumers of juice. Producers seek to provide products that retain their flavor and nutritional value in storage so that they can ensure that product delivered to consumers not only is flavorful, but also provides to the consumer a nutritious product. Consumers seek to purchase nutritious foods that are flavorful.

Juices of vegetables and fruits are valued by consumers as a convenient way of ingesting the nutrients found in the vegetables or fruits. Thus, producers of these popular juice products endeavor to maintain the nutrient content and to retain flavor through production and storage, i.e., during the shelf life of the product.

Methods of increasing stability, and therefore shelf life, are known. One such method is de-aeration, i.e., lowering the oxygen concentration in the juice. De-aeration at low temperature leads to less loss of volatile components than de-aeration at high temperature, but this method inevitably leads to loss of volatile components. Similarly, components are lost whether the juice is de-aerated by applying a vacuum or by bubbling an inert gas through a mass of juice.

Pathogen reduction also is commonly carried out on juice products. Juice can be sterilized or pasteurized with heat. Saturation of juice with an inert gas, such as the noble (inert) gasses, nitrogen, or helium, also serves to reduce aerobic pathogen growth. However, saturation with an inert gas can be expensive and time consuming. Such gasses also are used in the headspace, i.e., the unfilled volume of a storage container, to ameliorate degradation of products.

Thus, there exists a need for a method for processing juice that improves quality and nutritional value.

### BRIEF SUMMARY OF THE INVENTION

A first embodiment is directed to a method for processing and packaging juice.

A second embodiment is directed to a method for producing and packaging juice in a manner that minimizes exposure of the juice to oxygen.

A third embodiment is directed to a method for producing and packaging juice under conditions that yield juice having improved nutritional and organoleptic value.

A fourth embodiment is directed to juice produced in accordance with the method.

### DETAILED DESCRIPTION OF THE INVENTION

The invention relates to a method for producing and packaging juice. In particular, the invention relates to a method for producing and packaging juice having improved nutritional and organoleptic value. In an embodiment, juice is produced and packaged in a manner that reduces exposure of the juice to oxygen. In a second embodiment, juice is produced and packaged in a manner that minimizes exposure of the juice to oxygen. In another embodiment, the juice is produced and packaged in accordance with a method under conditions that minimize exposure of the juice to oxygen. In another embodiment, the invention also relates to juice having improved nutritional and organoleptic value produced in accordance with the method.

In an embodiment of the invention, juice is produced and packaged under conditions that control the oxygen concentration. Juice thus produced and packaged retains nutritional values significantly better than juice produced and packaged without regard to oxygen concentration during the process. For example, vitamin C concentration is about 50 percent higher after about 120 days storage when oxygen concentration is controlled than for typically-produced and packaged juice.

Vitamins and other oxidizeable nutrients and flavor compounds may be increased at extraction and better retained during storage in embodiments of this invention. However, for the sake of convenience, the embodiments of the invention are described as they relate to vitamin C. The skilled practitioner can, with the guidance provided herein, recognize that other vitamins and oxidizable nutrients and organoleptic components also will be retained.

In an embodiment, juice is produced and packaged under conditions that essentially preclude oxygen from the atmosphere under which the juice is produced and packaged. In this embodiment, oxygen is essentially excluded from contact with the juice from the juice extraction step to the packaging step. In another embodiment, oxygen concentration of less than about 10 percent is acceptable during extraction, pasteurization, and packaging and in the headspace of the package. In another embodiment, the oxygen concentration is less than about 3 percent, and less than about 2 percent in still another embodiment.

In accordance with these embodiments of the invention, the dissolved oxygen concentration in the juice will be low, and will therefore typically obviate the need for de-aeration. Thus, these embodiments save both time and money. However, de-aeration can be utilized, if preferred, to further lower the dissolved oxygen concentration in the juice.

Although this method can be applied to any fruit or vegetable juice, the method will be described herein as applied to citrus fruit juice. With the guidance provided herein, the skilled practitioner will be able to apply the method to other fruit and vegetable juices to obtain juices having significantly higher nutritional and organoleptic values than juices typically produced.

To produce citrus fruit juice, the fruit typically is washed or rinsed to remove debris and dirt. Then, the fruit is squeezed, pressed, or otherwise crushed, and the resultant juice is separately recovered from the remaining solids. The skilled practitioner recognizes that the fruit can be subjected to a ‘light squeeze,’ with the intention of recovering juice that typically may have lower concentrations of oils and other components typically liberated from the skin, for example, when a ‘heavy squeeze’ is used to obtain the juice. Any type of juicing is suitably used. The fruit may be split before it is squeezed, pressed, or crushed.

Any citrus fruit can be juiced in accordance with an embodiment. Often, oranges, grapefruits (red, pink, and white), lemons, and limes are juiced. Any variety or cultivar of fruit may be juiced. The skilled practitioner recognizes that Valencia and Hamlin oranges are preferred juice oranges and are commonly used to make orange juice commercially. The juice may contain pulp, or pulp may be removed.

In accordance with an embodiment of the invention, citrus fruit is juiced and packaged in an inert atmosphere. The purpose of the inert atmosphere is to preclude oxygen from contacting the juice extracted from the fruit.

The inert atmosphere is essentially devoid of oxygen and comprises compounds that are inert to nutrients and flavor components in the juice. Thus, the inert atmosphere during extraction, or juicing, is selected from the group consisting of nitrogen, carbon dioxide, helium, the noble gasses, and blends thereof. Preferably, the inert atmosphere is selected from the group consisting of nitrogen and the noble gasses, and blends thereof. More preferably, the inert atmosphere is nitrogen. Food grade inert gasses are used to create the inert atmosphere. Such gasses typically have a concentration of inerts exceeding 99.5 percent. Preferably, the inert concentration is at least about 99.75 percent, and more preferably at least about 99.95 percent. Thus, the oxygen concentration typically is less than about 0.5 percent, preferably is less than about 0.25 percent, and more preferably is less than 0.05 percent. Such inert gasses are available from commercial sources.

During juicing, an inert atmosphere is maintained in the entirety of the volume in contact with the juice. Any manner of maintaining an inert atmosphere in contact with the juice is suitable for use in the method.

Juicing may be done in any of the commercially-available juice extractor machines in which the atmosphere can be controlled. In the alternative, the machines can be installed inside a compartment in which the atmosphere can be controlled and can be made inert, as described below. In this way, the operator can be assured that oxygen will not contact the juice.

Juicing also may be done by hand. All steps of juicing carried out by hand can be done in a compartment, such as a glove box or other enclosed place. Often, the inert atmosphere in the compartment (whether for juicing by hand or by machine) or the juicing machine itself, if appropriate, is maintained at a slightly higher pressure than the surrounding atmosphere to ensure that oxygen does not leak into the compartment.

After juicing, rag, seeds, and other solids typically are separated from the juice. Similarly, pulp can be separated from the fluid juice or left in the juice. An inert atmosphere is maintained during any such separation steps.

The juice then typically is subjected to a spoilage and pathogen microorganism reduction step and packaged. Typically, sterilization or pasteurization is used to reduce spoilage and pathogens in the juice. Any such method of pathogen reduction known to the skilled practitioner can be used in accordance with embodiments of the invention. The inert atmosphere can be maintained during this step. In another embodiment, oxygen is present at a concentration of up to about 10 percent. In another embodiment, air is the atmosphere.

The resultant juice then is packaged. Any suitable packaging can be used. For example, the juice can be packaged in individual serving juice boxes or other containers, or in larger bottles, whether glass or plastic, lined paperboard containers, or any other package suitable for packaging juice. The package preferably is resistant to ingress by oxygen during the storage period. Exclusion of oxygen during storage helps maintain the nutritive and organoleptic value of the juice.

During packaging, the atmosphere preferably is essentially devoid of oxygen. However, in another embodiment, an oxygen concentration of less than about 3 percent is used. In another embodiment, the oxygen concentration is less than about 10 percent.

Containers in which juice is stored will have a headspace, i.e., a volume in the container that is not filled with fluid juice. Typically, this headspace is filled with air. However, in embodiments of this invention, the headspace is filled with inert gas in which the oxygen concentration may be controlled.

The oxygen concentration is the headspace preferably is limited to a concentration lower than atmospheric. In an embodiment, the oxygen concentration in the head space is less than about 10 percent. In embodiments of the invention, the concentration of oxygen in the headspace of the filled container is less than about 3 volume percent, preferably less than about 2 volume percent, and more preferably less than about 1 volume percent.

Embodiments of the invention reduce the concentration of oxygen in the atmosphere during juicing (extraction) and other embodiments reduce the oxygen concentration in the atmosphere during both juicing and additional processing, such as pasteurization and packaging.

Reducing the oxygen concentration in the atmosphere during processing reduces the availability of a key reactant for autocatalytic free radical propagation. Thus, the reduction in oxygen concentration reduces formation of several compounds that produce off-flavors, such as but not limited to para-vinylguaiacol, carvone, carveol, epoxylimonene, alpha-para-dimethylstyrene, para-methylacetophenone, and trans-hexenal.

Similarly, this reduction in oxygen concentration reduces oxidation of compounds present in the juice. Hence, the concentrations of flavor components and nutrients, such as vitamins, are retained because they are not oxidized. Sulfur-containing compounds, such as dimethyl sulfide, dimethyl disulfide, hydrogen sulfide, and methanethiol, also are retained.

Maintaining an atmosphere essentially devoid of oxygen during extraction juicing) and packaging yields a juice that has a measurably higher concentration of nutrients than juice exposed to oxygen during extraction. For example, the concentration of vitamin C in juice within one day of production is about 8 percent higher than that of typical juice produced by known methods. During storage in containers that essentially preclude ingress of oxygen, juice produced in accordance with embodiments of this invention also maintains a higher concentration of vitamin C. After 3 months, the concentration of vitamin C of juice produced in accordance with an embodiment of the invention is about 30 percent higher than that of typical juice produced by known methods. After 4 months, the concentration of vitamin C of juice produced in accordance with an embodiment of the invention is about 50 percent higher than that of typical juice produced by known methods. The skilled practitioner recognizes that 3 months is an acceptable shelf life for a citrus juice, and 4 months is a fairly long shelf life for a citrus juice.

The following examples are intended to illustrate the embodiments of the invention, and are not to be considered limiting in any way.

### EXAMPLES AND COMPARATIVE EXAMPLES

### Example 1 and Comparative Examples 1-3

Orange juice was prepared in accordance with embodiments of the invention and in accordance with other methods to provide comparative examples. Valencia oranges were selected randomly from a single batch of fruit for all examples.

In each example, the oranges were hand-squeezed in the atmosphere described in the table below in the column entitled “Extraction.” Pulp was removed by straining. In Comparative Example 3, juice was de-aerated immediately after extraction by bubbling nitrogen through the juice at a temperature of 40° F. (4.5° C.) until the dissolved oxygen in the juice (DO) was less than 1.0 ppm.

Then, for each example and comparative example, juice was pasteurized in a standard pasteurization step on laboratory-scale equipment.

Pasteurized juice then was packaged in glass containers. Headspace volume was controlled by controlling the weight of the juice packaged in each container. In the Example and in Comparative Example 1, the oxygen concentration in the headspace was controlled to be less than 3 percent by controlling the oxygen concentration in the packaging area. Filled containers then were stored at 35° F.

The following table summarizes processing steps and conditions for each Example and Comparative Example:

TABLE 1

| | | | De- | |
|---|---|---|---|---|
| | Summary | Extraction | aeration | Headspace |
| Example 1 | Low O₂ through | O₂ < 3 | N/A | O₂ < 3 |
| | packaging | percent | | percent |
| Comparative | No O₂ control in | Atmosphere | N/A | O₂ < 3 |
| Example 1 | extraction; no de- | | | percent |
| | aeration, with O₂ | | | |
| | control in | | | |
| | packaging | | | |
| Comparative | Standard Process | Atmosphere | N/A | Atmosphere |
| Example 2 | | | | |
| Comparative | Standard Process | Atmosphere | DO < 1.0 | Atmosphere |
| Example 3 | with De-aeration | | ppm | |

Note:
DO means Dissolved Oxygen

Vitamin C was determined at selected storage intervals for Example 1 and Comparative Examples 1, 2, and 3, as set forth in Table 2 below. The data indicate clearly that Vitamin C retention immediately after packaging and after 90 and 120 days (3 and 4 months) storage in juice obtained in accordance with an embodiment of this invention were about 8, about 30, and about 50 percent higher, respectively, than juice obtained without oxygen control, and were about 8, about 15, and about 20 percent higher, respectively, than juice obtained with only headspace oxygen concentration control.

TABLE 2
Vitamin C concentration, mg/100 g

| | Days In Storage | | | | |
|---|---|---|---|---|---|
| | 0 | 30 | 60 | 90 | 120 |
| Example 1 | 33 | 34 | 32 | 33 | 27 |
| Comparative | 31 | 31 | 29 | 28.5 | 23 |
| Example 1 | | | | | |
| Comparative | 31 | 30 | 26.5 | 23 | 18 |
| Example 2 | | | | | |
| Comparative | 31 | 30 | 29 | 25 | 19 |
| Example 3 | | | | | |

The skilled practitioner recognizes that a difference of 1 mg/100 g is within analytical variability of the assay. Therefore, these data may be better considered to indicate trends within data, rather than benchmarks. As can be seen, juice from Comparative Example 2, which had the most oxygen exposure, had the least vitamin C to start and retained less than about 60 percent of the vitamin C. The juice of Example 1, which had the least oxygen exposure, started with a higher vitamin C concentration, and retained a significantly greater percentage (more than about 80 percent). Comparative Example 1, which had an intermediate oxygen exposure, had intermediate results. Comparative Example 3, which had slightly less oxygen exposure than Comparative Example 2, yielded vitamin C retained concentrations marginally better than Comparative Example 2.

### Example 2

Grapefruit juice is obtained by juicing grapefruits under an atmosphere comprising at least about 99.5 percent inert compounds. Thus-obtained juice then is pasteurized in accordance with known techniques and packaged in containers resistant to oxygen under two sets of conditions.

Under the first set of conditions, the oxygen concentration in the atmosphere during pasteurization and in the headspace is controlled to less than 10 percent. Under the second set of conditions, the oxygen concentration in the atmosphere during pasteurization and in the headspace is controlled to about 2 percent.

Under both sets of conditions, the nutritional value of the grapefruit juice thus obtained, as reflected in the vitamin C content, exceeds the value of grapefruit juice obtained in all with known methods, both after squeezing and throughout a storage period of 4 months at about 35° F.

### Example 3

Orange juice is squeezed as set forth in Example 1, then de-aerated to obtain a dissolved oxygen concentration of less than about 1 ppm. The remainder of the processing steps of Example 1 then is followed. The orange juice is stored for 4 months at 35° F., and samples are testing at intervening periods.

The vitamin C concentrations of the samples taken at the same periods as those of Example 1 are comparable to those of Example 1.

### Example 4

The juices produced in Example 1 and Comparative Examples 1, 2, and 3, are tasted after packaging. The juice of Example 1 is found to have superior taste as compared with the Comparative Examples 1-3.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

1. A method for producing juice having improved nutritional and organoleptic value, said method comprising extracting juice in an atmosphere having an oxygen concentration less than about 10 percent.

2. The method of claim 1, further comprising heat treating the extracted juice under an atmosphere having an oxygen concentration less than about 10 percent.

3. The method of claim 1, further comprising packaging the extracted juice under an atmosphere having an oxygen concentration less than about 10 percent.

4. The method of claim 2, further comprising packaging the heat treated juice under an atmosphere having an oxygen concentration less than about 10 percent.

5. The method of claim 1 wherein the atmosphere has an oxygen concentration less than about 3 percent.

6. The method of claim 4 wherein each atmosphere has an oxygen concentration less than about 3 percent.

7. The method of claim 5 wherein the atmosphere has an oxygen concentration less than about 0.5 percent.

8. The method of claim 6 wherein during extraction the atmosphere has an oxygen concentration less than about 0.5 percent.

9. Juice that retains at least about 60 percent of the content of at least one vitamin after about 3 months in storage.

10. The juice of claim 9 wherein the retention is at least about 80 percent.

11. The juice of claim 10 wherein the vitamin is vitamin C.

12. A method for increasing the nutritional and organoleptic value of juice, said method comprising extracting juice in an atmosphere having an oxygen concentration less than about 10 percent.

13. The method of claim 12, further comprising heat treating the extracted juice under an atmosphere having an oxygen concentration less than about 10 percent

14. The method of claim 12, further comprising packaging the heat treated juice under an atmosphere having an oxygen concentration less than about 10 percent.

15. The method of claim 13, further comprising packaging the extracted juice under an atmosphere having an oxygen concentration less than about 10 percent.

16. The method of claim 14 wherein the atmosphere has an oxygen concentration less than about 3 percent.

17. The method of claim 15 wherein each atmosphere has an oxygen concentration less than about 3 percent.

18. The method of claim 16 wherein the atmosphere has an oxygen concentration less than about 0.5 percent.

19. The method of claim 17 wherein during extraction the atmosphere has an oxygen concentration less than about 0.5 percent.
